(19) United States
(12) Patent Application Publication
(10) Pub. No.: US 2023/0286065 A1
(43) Pub. Date: Sep. 14, 2023

(54) BORING TOOL WITH MULTI-ANGLED TIP

(71) Applicant: Apex Brands, Inc., Apex, NC (US)

(72) Inventor: LaVerne Royal Durfee, Statesville, NC (US)

(21) Appl. No.: 18/119,950

(22) Filed: Mar. 10, 2023

Related U.S. Application Data
(60) Provisional application No. 63/318,977, filed on Mar. 11, 2022.

(51) Int. Cl. B23B 51/02

(52) U.S. Cl. CPC B23B 51/02; B23B 2251/04; B23B 2251/18; B23B 2251/60

(57) ABSTRACT

A boring tool may include a coupling portion for interfacing with a powered driver, a shank operably coupled to the coupling portion, a cutting portion operably coupled to the shank, and a cutting portion. The cutting portion may be defined by a plurality of helical cutting flutes. The cutting tip may be operably coupled to a distal end of the cutting portion relative to the shank. The coupling portion, the shank, the cutting portion and the cutting tip may all share an axis. The cutting tip may include an inner portion and an outer portion. The inner portion may be defined by inner faces bisected by the axis and extending a first radial distance away from the axis to define a first point angle between the inner faces. The outer portion may be defined by outer faces extending from respective ones of the inner faces at the first radial distance to a second radial distance equal to a radius of the cutting portion to define a second point angle between the outer faces, and the second point angle may be less than the first point angle.

### TECHNICAL FIELD

Example embodiments generally relate to drilling or boring devices such as drill bits or other tools for forming bore holes in a base material.

### BACKGROUND

Boring or cutting tools, such as drill bits, often have a drive end that includes a conventional interface for receiving drive energy from a powered driving device (e.g., a drill). The drive end may have a standard sized hex head or another conventional drive end geometry that enables the powered driving device to impart rotational force on the boring tool. The boring tool may also have a cutting end at which location a cutting point and/or cutting edges may be formed. By providing rotational energy to the drive end, the cutting end may bore a hole in the material or workpiece on which the boring tool is being used.

A drill bit is one example of a boring tool that has been around a long time, and remains an extremely useful component to many tool kits. Most drill bits have helical shaped cutting flutes that extend across a cutting portion thereof, from a tip of the drill bit toward a shank of the drill bit. In this familiar context, the tip of the drill bit typically has a point that can be distinguished by the angle of the point (or point angle). There are two common point angles (namely 118 degrees and 135 degrees) that are employed on bits that are tailored to specific purposes suited to whichever one of the angles is selected. In the past, one of these point angles would be selected prior to machining the drill bit depending on the expected use of the drill bit, and the tip would be machined to a conical shape at the corresponding selected angle. These conical tips have since given way to the introduction of facets to enable a chisel action to be performed by the tip. However, even with the chisel action being introduced, such bits typically still have a single consistent point angle.

### BRIEF SUMMARY OF SOME EXAMPLES

According to some example embodiments, an example boring tool is provided. The boring tool may include a coupling portion for interfacing with a powered driver, a shank operably coupled to the coupling portion, a cutting portion operably coupled to the shank, and a cutting portion. The cutting portion may be defined by a plurality of helical cutting flutes. The cutting tip may be operably coupled to a distal end of the cutting portion relative to the shank. The coupling portion, the shank, the cutting portion and the cutting tip may all share an axis. The cutting tip may include an inner portion and an outer portion. The inner portion may be defined by inner faces bisected by the axis and extending a first radial distance away from the axis to define a first point angle between the inner faces. The outer portion may be defined by outer faces extending from respective ones of the inner faces at the first radial distance to a second radial distance equal to a radius of the cutting portion to define a second point angle between the outer faces, and the second point angle may be less than the first point angle.

According to some example embodiments, a method of forming a boring tool is provided. The method may include machining the boring tool such that the boring tool includes a cutting tip, a shank, and a cutting portion sharing an axis, and machining the cutting portion to define helical cutting flutes that extend from the cutting tip to the shank. The method may also include machining the cutting tip to define an inner portion including inner faces bisected by the axis and extending a first radial distance away from the axis to define a first point angle between the inner faces, and an outer portion including outer faces extending from respective ones of the inner faces at the first radial distance to an outer diameter of the cutting portion to define a second point angle between the outer faces. In this context, the second point angle may be less than the first point angle.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a side view of a boring tool according to an example embodiment;

FIG. 2 illustrates a side view of another boring tool according to an example embodiment;

FIG. 3 illustrates a side view of yet another boring tool according to an example embodiment;

FIG. 4 illustrates a side view of still another boring tool according to an example embodiment;

FIG. 5 illustrates a partially exploded view of a cutting portion of a boring tool having a dual tip geometry according to an example embodiment;

FIG. 6 illustrates a partially exploded view of a cutting portion of a boring tool having multiple cutting surfaces and a cutting tip according to an example embodiment; and

FIG. 7 illustrates block diagram of a method of forming a boring tool according to an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

As indicated above, some example embodiments may relate to the provision of a boring tool (e.g., a drill bit) with multi-angled cutting edges. In an example embodiment, the boring tool may be constructed in such a way as to integrate a plurality of angled cutting edges into a cutting point angle. The cutting point angle may further comprise multiple angles. Thus, a double angle point of the tip of the boring tool may be automatically formed. Some structures that can employ example embodiments will now be described below by way of example and not limitation.

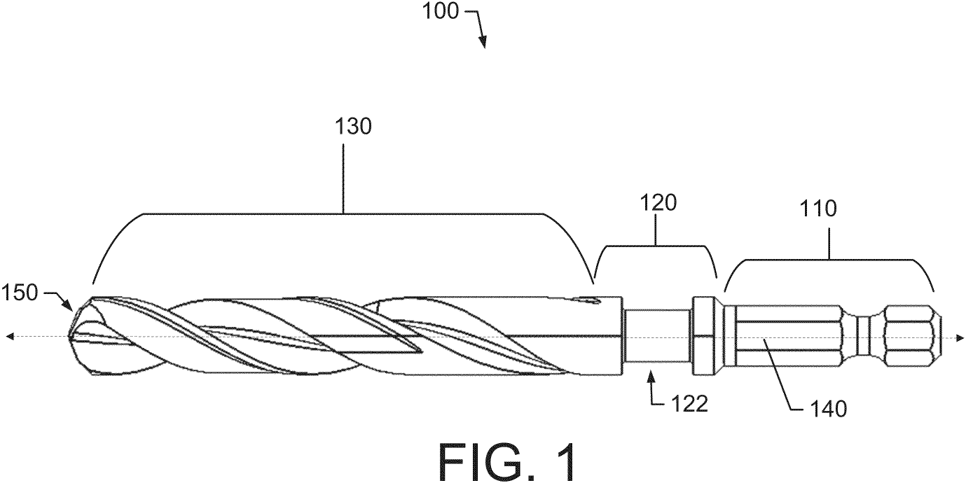

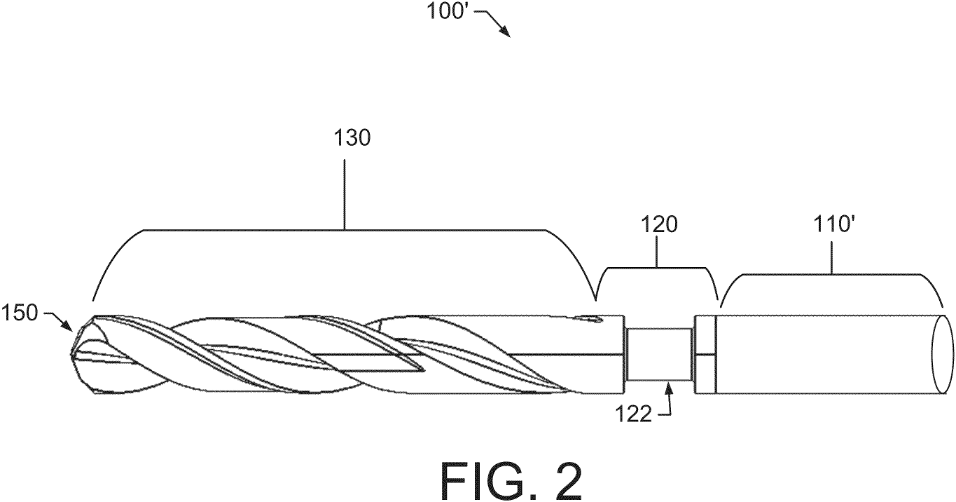

FIG. 1 illustrates a side view of a boring tool 100 according to an example embodiment, as one example of a boring tool. As can be seen in FIG. 1, the boring tool 100 may include a coupling portion 110, a shank 120, a cutting portion 130 and a cutting tip 150. The coupling portion 110, the shank 120, the cutting portion 130 and the cutting tip 150 may all share a common axis 140 that extends longitudinally through a middle of the boring tool 100. The coupling portion 110 and the shank 120 shown in FIG. 1 may be varied in certain ways in alternative embodiments without departing from the scope of embodiments of the present invention. In this regard, FIGS. 2-4 illustrate various alternative structures to the structures shown for the coupling portion 110 and shank 120 of FIG. 1. Thus, the boring tools 100′, 100″ and 100‴ of FIGS. 2-4, respectively, include slight modifications to the basic structures shown in FIG. 1, and the modifications will be described in greater detail below.

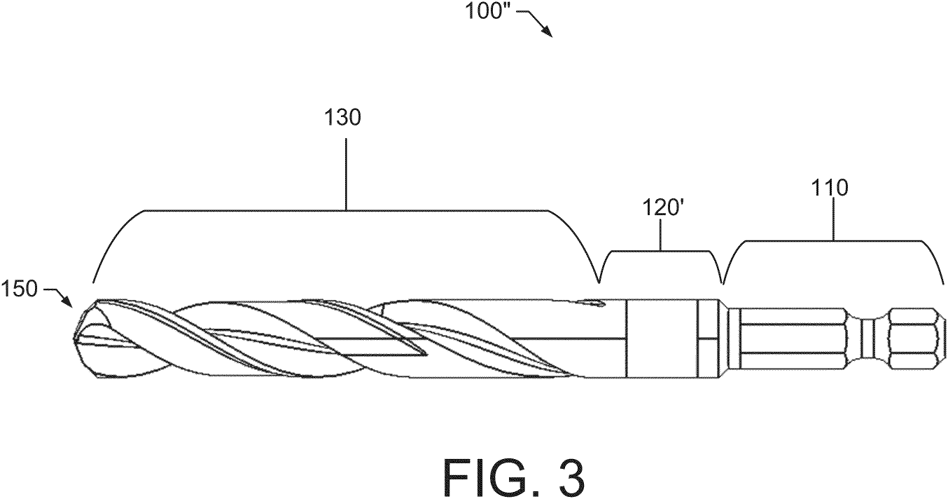

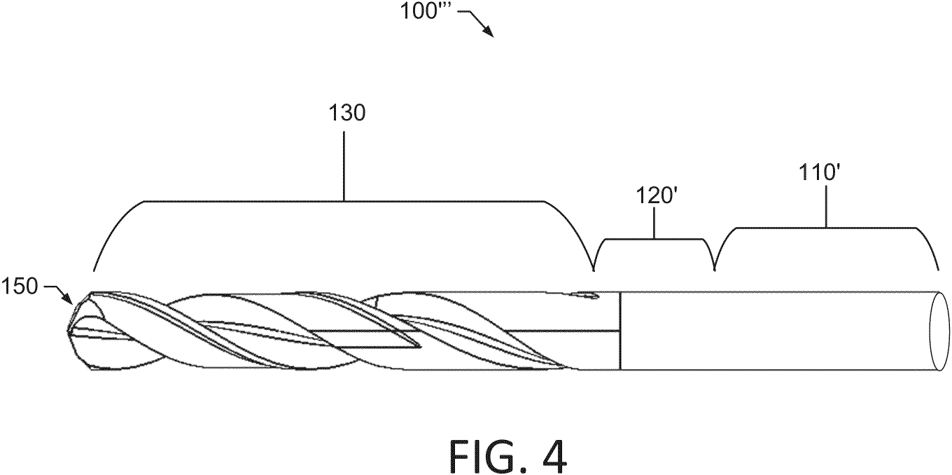

The coupling portion 110 may be configured to operably couple the boring tool 100 to an external device that may provide torque to the boring tool 100. In this regard, the coupling portion 110 may be a part of the boring tool 100 that receives a torque force. In some embodiments, the device may be a handheld power tool such as a drill or an impact driver. In some embodiments, the coupling portion 110 of the boring tool 100 may be configured to have a non-circular outer surface to facilitate translating torque from the device to the boring tool 100. For example, the coupling portion 110 may have a hexagonally shaped cross section to facilitate engagement with a driving device such as a drill. In FIGS. 1 and 3, the coupling portion 110 is shown as a ¼ inch hex coupler. However, in some cases, the coupling portion 110′ may be cylindrical in shape, and thus have a circular cross section. FIGS. 2 and 4 illustrate the coupling portion 110′ of alternative embodiments. The boring tools 100, 100′, 100″ and 100‴ therefore show various combinations of different shanks 120 and 120′ and coupling portions 110 and 110′ that may be included in various example embodiments.

The shank 120 may operably couple the coupling portion 110 to the cutting portion 130. Thus, the shank 120, may assist with translating torque from receiving devices into rotational motion of the cutting portion 130. The shank 120 may have a proximal end that may be operably coupled to a distal end of the coupling portion 110. In this regard, the terms proximal and distal may be relative to the driving device when the boring tool 100 is attached thereto. The cutting portion 130 may be operably coupled to a distal end of the shank 120 at a proximal end of the cutting portion 130. The shank 120 may therefore be understood to transfer torque applied at the coupling portion 110 to the cutting portion 130. Therefore, the shank 120 may be subjected to high torsional loading due to the shank 120 forming a connection between the coupling portion 110 and the cutting portion 130, both of which may experience opposing forces while the boring tool 100 is in use. In this regard, the driving device may exert a torque on the coupling portion 110 that may oppose the direction of rotation of the boring tool 100. Thus, these opposing forces may be naturally distributed throughout the boring tool 100.

The shank 120 may typically have a consistent or same diameter between the proximal and distal ends thereof. However, in the example of FIGS. 1 and 2, the shank 120 is provided with one portion, or zone, that has a smaller diameter than other portions of the shank 120. This portion or zone may be referred to as a torsion zone 122. The torsion zone 122 may be a portion of the shank 120 having a diameter that is reduced in size relative to surrounding portions thereof. In various examples, the diameter of the torsion zone 122 may be anywhere from 80% to 95% a diameter of the other portions of the shank 120. The reduced diameter of the torsion zone 122 may provide for a zone in which additional twisting and heat generation and release may be accomplished to improve the performance of the boring tool 100. FIGS. 3 and 4 illustrate an alternative shank 120′, which does not include the torsion zone 122 and instead shows the shank 120′ having a substantially constant diameter.

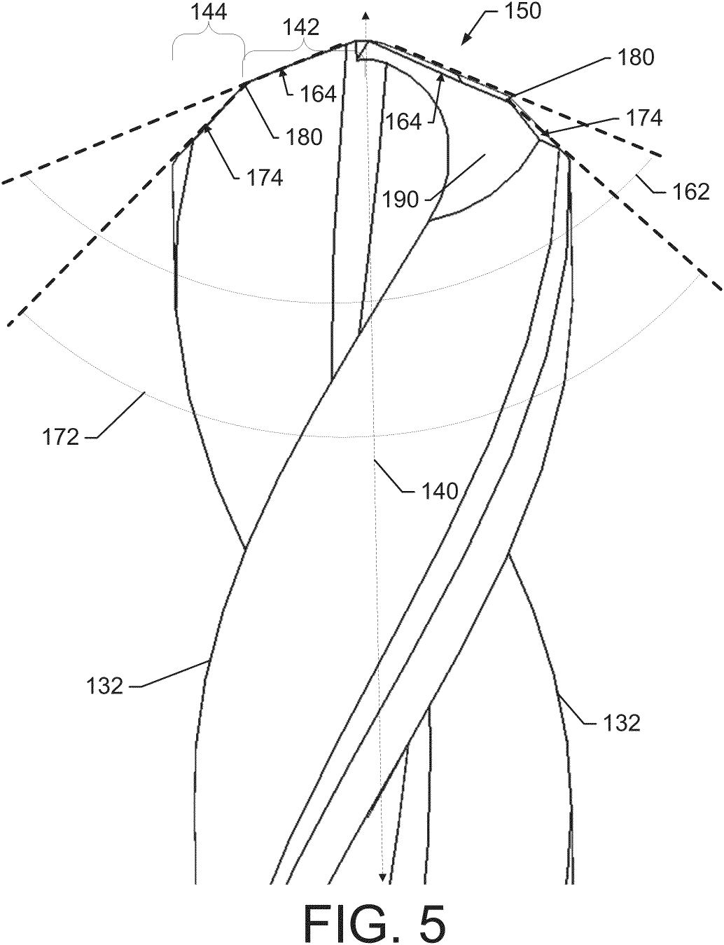

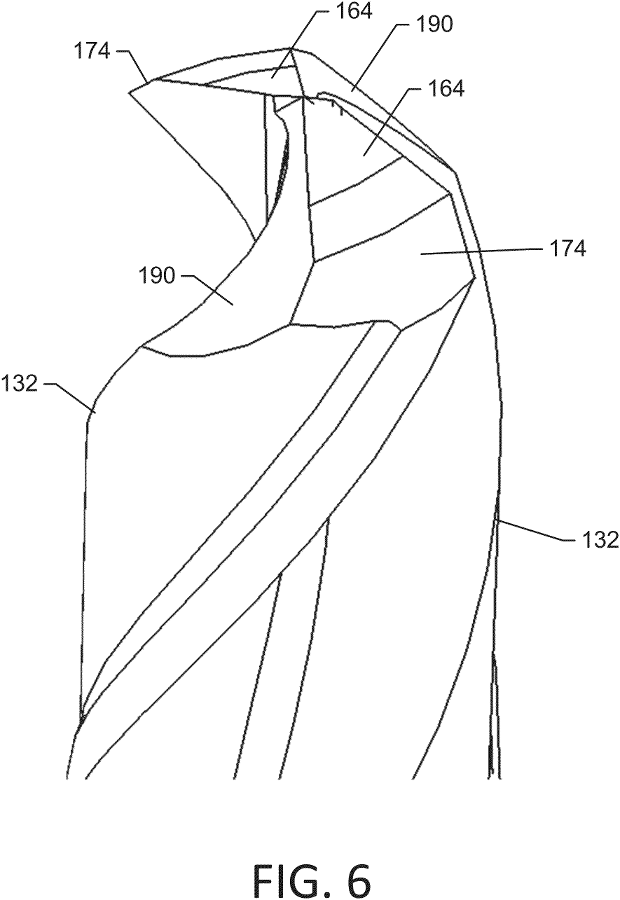

The cutting portion 130 of an example embodiment may include a plurality of helical cutting flutes 132 that extend from a cutting tip 150 at the distal end of the cutting portion 130 to the shank 120 at the proximal end of the cutting portion 130. The cutting flutes can assist in forming and transporting chips or other material released by the cutting action of the boring tool 100 out of the hole drilled. Meanwhile, the cutting tip 150, rather than having a conventional conical shape, may be formed to have portions thereof at two distinct angles relative to the axis 140. The portions of the cutting tip 150 may be referred to as a first portion (i.e., an inner portion 160 in this example) and a second portion (i.e., an outer portion 170 in this example), which are shown in greater detail in FIGS. 5 and 6. The inner and outer portions 160 and 170 are distinguished by their respective distances from the axis 140. In this regard, the inner portion 160 is closest to (and in this case starts at) the axis 140, extending away from the axis 140 by a first radial distance 142. The outer portion 170 is farther from (and in this case spaced apart from) the axis 140. The outer portion 170 extend from the first radial distance 142 to a second radial distance 144, which corresponds to the radius of the cutting portion 130. The inner portion 160 extends from the axis 140 to a transition 180, which is located the first radial distance away from the axis 140. The transition 180 is the point at which the point angle of the inner portion 160 changes to the point angle of the outer portion 170.

As shown in FIG. 5, the inner portion 160 may define a first point angle 162 between respective inner faces 164 of the cutting tip 150. Thus, for example, the inner faces 164 may extend away from each other and the axis 140 on opposite sides of the axis 140. Each of the inner faces 164 may be a substantially planar surface and the first point angle 162 may be measured between the two planar surfaces formed by the inner faces 164. The inner faces 164, and the first angle 162, may be bisected (or nearly so) by the axis 140. In this example, the first point angle 162 may be about 135° +/-5°. In other words, the first point angle 162 may be between about 130° and 140°.

The outer portion 170 may define a second point angle 172 between respective outer faces 174 of the cutting tip 150. One instance of the outer faces 174 may extend away from each respective one of the inner faces 164. The outer faces 174 may also be substantially planar surfaces, and the second point angle 172 may be defined between the planar surfaces. The second point angle 172 may be 118° +/- about 8°, although other embodiments may be 118° +/- about 3°. Thus, the second point angle 172 may be between about 110° and 126°, or between about 113° to about 123°. The transition 180 may be a distinct transition between the inner faces 164 (of which there are two shown in the example of FIGS. 5 and 6) and the outer faces 174 (of which there are two shown in the example of FIGS. 5 and 6). When the transition 180 is distinctly formed, the change from the first point angle 162 to the second point angle 172 may be immediate or instantaneous, occurring at the transition 180. However, alternative embodiments may define a more gradual or curved transition between the inner and outer faces 164 and 174. Since the boring tool 100 may be formed by machining a single unitary piece of metallic material (e.g., bar stock), it may be appreciated that the distinct transition may be easier and preferred to create. Moreover, it should also be appreciated that the coupling portion 110 may be a distinct component joined to the shank 120 in some cases. So two piece designs are also possible, particularly for ¼ inch hex designs. Materials used for forming the cutting portion 130 and cutting tip 150 may include high-speed steel and cobalt infused materials.

Although not required, some example embodiments may further include an additional relief facet 190 defined at a portion of the inner and outer faces 164 and 174 that is opposite the leading edge of each of the inner and outer faces 164 and 174. The relief facet 190 may form a relief area behind the inner and outer faces 164 and 174 to provide for improved chip removal.

As a result of the cutting tip 150 having multiple cutting surfaces and at least one inside cutting region (i.e., inner portion 160) and at least one outside cutting region (i.e., outer portion 170), the cutting tip 150 may include two differently angled cutting surfaces. Accordingly, the boring tool 100, 100′, 100″ and 100‴ may be used for a variety of materials, and may provide good cutting characteristics for each of multiple different materials. For example, boring tools with a single cutting point angle of around 118° radially defined about the axis of the boring tool allows for drilling into soft materials such as wood, aluminum, brass, cast iron or plastic. Meanwhile, boring tools with a single cutting point angle of around 135° may be used for boring into harder materials such as harder metals. Example embodiments, by providing two different cutting point angles, may provide superior performance across a variety of materials. For example, a boring tool cutting tip with a combination of at least an angle of at least 110° and an angle of at least 130° may allow for the boring tool to be used for drilling soft and hard materials while also allowing efficiently expelling chips from the hole being drilled. In this regard, a typical bit wears first at the outer edge of the cutting tip, since speeds are highest at the outside of the bit. Example embodiments may provide more metal and a less significant angle to reduce the heat generation at the outside of the bit. Example embodiments may therefore not necessarily only be used for purely rotational driving devices. Instead, example embodiments may be employed as impact drill bits for use with an impact driver.

Some example embodiments may therefore provide a boring tool. The boring tool may include a coupling portion for interfacing with a powered driver, a shank operably coupled to the coupling portion, a cutting portion operably coupled to the shank, and a cutting portion. The cutting portion may be defined by a plurality of helical cutting flutes. The cutting tip may be operably coupled to a distal end of the cutting portion relative to the shank. The coupling portion, the shank, the cutting portion and the cutting tip may all share an axis. The cutting tip may include an inner portion and an outer portion. The inner portion may be defined by inner faces bisected by the axis and extending a first radial distance away from the axis to define a first point angle between the inner faces. The outer portion may be defined by outer faces extending from respective ones of the inner faces at the first radial distance to a second radial distance equal to a radius of the cutting portion to define a second point angle between the outer faces, and the second point angle may be less than the first point angle.

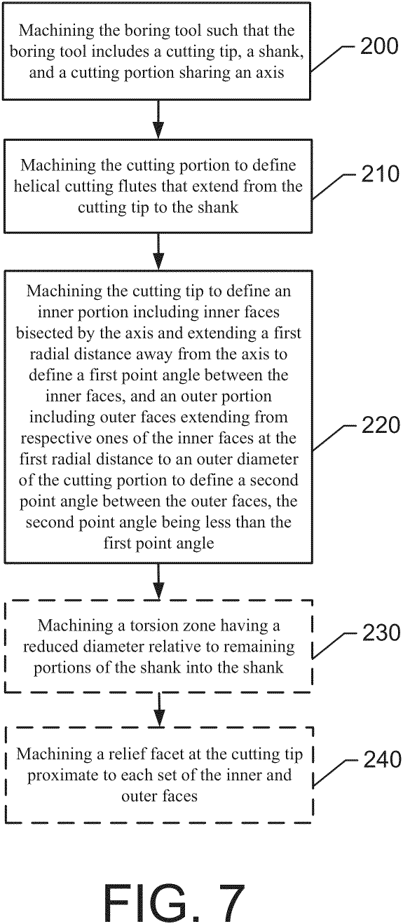

FIG. 7 shows a block diagram of a method of making a boring tool in accordance with an example embodiment. As shown in FIG. 7, the method may include machining the boring tool (e.g., from a piece of bar stock) such that the boring tool includes a cutting tip, a shank, and a cutting portion sharing an axis at operation 200. The method may further include machining the cutting portion to define helical cutting flutes that extend from the cutting tip to the shank at operation 210. The method may also include machining the cutting tip to define an inner portion including inner faces bisected by the axis and extending a first radial distance away from the axis to define a first point angle between the inner faces, and an outer portion including outer faces extending from respective ones of the inner faces at the first radial distance to an outer diameter of the cutting portion to define a second point angle between the outer faces at operation 220. In this context, the second point angle may be less than the first point angle.

Although not required, the method described above may be modified, or additional operations may be included. Some example modifications may include the first radial distance being between about ¼ to ¾ a radius of the cutting portion. Another modification that may also or alternatively be included may be that the first point angle is 135° +/- 5° and the second point angle is 118° +/- 8°. Another modification that may also or alternatively be included may be that a transition between the first point angle and the second point angle is either a distinct angular transition or a curved transition. An example of an additional operation (shown in dashed lines) may include machining a torsion zone having a reduced diameter relative to remaining portions of the shank into the shank at operation 230. The torsion zone may have a diameter that is between about 80% and 95% a diameter of the remaining portions of the shank. Another example of an additional operation (shown in dashed lines) may include machining a relief facet at the cutting tip proximate to each set of the inner and outer faces at operation 240.

The boring tool of some embodiments may include additional features, modifications, augmentations and/or the like to achieve further objectives or enhance performance of the boring tool. The additional features, modifications, augmentations and/or the like may be added in any combination with each other. Below is a list of various additional features, modifications, and augmentations that can each be added individually or in any combination with each other. For example, the first radial distance may be between about ¼ to ¾ of the radius of the cutting portion. In an example embodiment, the first point angle may be 135° +/- 5° and the second point angle may be 118° +/- 8°. In some cases, the first point angle may be about 135° and the second point angle may be about 118°. In an example embodiment, the shank may include a torsion zone having a reduced diameter relative to remaining portions of the shank. The torsion zone may have a diameter that is between about 80% and 95% a diameter of the remaining portions of the shank. In some cases, the boring tool may be formed from high-speed steel or a cobalt infused material. In an example embodiment, the boring tool may be an impact bit and the powered device may be an impact driver. In some cases, the coupling portion may be either cylindrical or a ¼ inch hex head. In an example embodiment, the first radial distance may define a transition between the inner faces and the outer faces, respectively. In various examples, the transition may define either a distinct transition between the first point angle and the second point angle, or a curved transition between the first point angle and the second point angle.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. A boring tool comprising:
a coupling portion for interfacing with a powered driver;
a shank operably coupled to the coupling portion;
a cutting portion operably coupled to the shank, the cutting portion being defined by a plurality of helical cutting flutes; and
a cutting tip operably coupled to a distal end of the cutting portion relative to the shank,
wherein the coupling portion, the shank, the cutting portion and the cutting tip share an axis,
wherein the cutting tip comprises:
an inner portion defined by inner faces bisected by the axis and extending a first radial distance away from the axis to define a first point angle between the inner faces, and
an outer portion defined by outer faces extending from respective ones of the inner faces at the first radial distance to a second radial distance equal to a radius of the cutting portion to define a second point angle between the outer faces, the second point angle being less than the first point angle.

2. The boring tool of claim 1, wherein the first radial distance is between about ¼ to ¾ of the radius of the cutting portion.

3. The boring tool of claim 1, wherein the first point angle is 135° +/- 5° and the second point angle is 118° +/- 5°.

4. The boring tool of claim 3, wherein the first point angle is 135° and the second point angle is 118°.

5. The boring tool of claim 1, wherein the shank comprises a torsion zone having a reduced diameter relative to remaining portions of the shank, and
wherein the torsion zone has a diameter that is between about 80% and 95% a diameter of the remaining portions of the shank.

6. The boring tool of claim 1, wherein the boring tool is formed from high-speed steel.

7. The boring tool of claim 1, wherein the boring tool is formed of a cobalt infused material.

8. The boring tool of claim 1, wherein the boring tool is an impact bit and the powered device is an impact driver.

9. The boring tool of claim 1, wherein the coupling portion is cylindrical.

10. The boring tool of claim 1, wherein the coupling portion is a ¼ inch hex head.

11. The boring tool of claim 1, wherein the first radial distance defines a transition between the inner faces and the outer faces, respectively.

12. The boring tool of claim 11, wherein the transition defines a distinct transition between the first point angle and the second point angle.

13. The boring tool of claim 1, wherein the transition defines a curved transition between the first point angle and the second point angle.

14. A method of making a boring tool, the method comprising:
machining the boring tool such that the boring tool includes a cutting tip, a shank, and a cutting portion sharing an axis;
machining the cutting portion to define helical cutting flutes that extend from the cutting tip to the shank; and
machining the cutting tip to define an inner portion including inner faces bisected by the axis and extending a first radial distance away from the axis to define a first point angle between the inner faces, and an outer portion including outer faces extending from respective ones of the inner faces at the first radial distance to an outer diameter of the cutting portion to define a second point angle between the outer faces, the second point angle being less than the first point angle.

15. The method of claim 14, wherein the first radial distance is between about ¼ to ¾ a radius of the cutting portion.

16. The method of claim 14, wherein the first point angle is 135° +/- 5° and the second point angle is 118° +/- 5°.

17. The method of claim 16, wherein the first point angle is 135° and the second point angle is 118°.

18. The method of claim 14, further comprising machining a torsion zone having a reduced diameter relative to remaining portions of the shank into the shank,
wherein the torsion zone has a diameter that is between about 80% and 95% a diameter of the remaining portions of the shank.

19. The method of claim 14, wherein a transition between the first point angle and the second point angle comprises a distinct angular transition.

20. The method of claim 14, further comprising machining a relief facet at the cutting tip proximate to each set of the inner and outer faces.
